(19) United States
(12) Patent Application Publication
(10) Pub. No.: US 2007/0194721 A1
(43) Pub. Date: Aug. 23, 2007

(54) Electronic lighting ballast with multiple outputs to drive electric discharge lamps of different wattage

(76) Inventors: Vatche Vorperian, Irvine, CA (US); Igor Pogodayev, Huntington Beach, CA (US); Ronald Flores, Huntington Beach, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/206,476

(22) Filed: Aug. 17, 2005

Related U.S. Application Data
(60) Provisional application No. 60/603,400, filed on Aug. 20, 2004.

(51) Int. Cl. H05B 41/24

(52) U.S. Cl. 315/247

(57) ABSTRACT

A number of elements are integrated within an electronics enclosure. A non-inverting buck-boost converter is to operate in the continuous conduction mode designed to provide an average power of more than 200 watts at its DC output. A power bus is coupled to the DC output. Multiple inverter circuits are coupled to the power bus in parallel, each inverter circuit having a respective output to drive a respective electric discharge lamp. Other embodiments are also described and claimed.

This application claims the benefit of the earlier filing date of U.S. Provisional Application Ser. No. 60/603,400 filed Aug. 20, 2004, entitled “Lighting Control System with Multiple Output Intelligent Power Switching Elements”.

### BACKGROUND

Ballasts are an integral component of the lighting industry and are either magnetic or electronic. Magnetic ballasts utilize components which are heavy and cumbersome, while electronic ballasts use electric circuits on a light-weight and reduced size circuit board. A ballast may be used to start a high intensity discharge (HID) lamp, and regulates electrical current used by the lamp. HID lamps are identified by the gas within the lamp—metal halide (MH), high-pressure sodium (HPS) or mercury vapor (MV)—and the gas affects the color of the light. Buyers choose a specific HID lamp based on the color, input voltage, output wattage and the starter (regular or pulse start).

There are two categories of HID ballast: magnetic and electronic. Magnetic ballasts, also called “core and coil” ballasts, dominate the HID market. Although inexpensive, magnetic ballasts flicker, are noisy and weigh as much as 86 lbs. Ballast manufacturers have redesigned their products to reduce electronic interference and noise, and lamp manufacturers have introduced pulse-start lamps to shorten the slow start times. Despite these improvements, magnetic ballasts are still energy-inefficient. Regulatory actions and fines threaten the long-term outlook for magnetic ballasts and, as they fail, many are being replaced with electronic ballasts.

Electronic ballasts may be 30-50% more energy-efficient than magnetic ballasts and deliver a relatively non-flickering, silent light, reduce the problem of magnetic interference, and may weigh less then 8 lbs. Until now, however, most electronic ballast manufacturers have followed a short-sighted, one-to-one design approach, requiring a unique electronic ballast for every input voltage, output wattage and lamp type combination. As an example, a 400 watt lamp from a certain manufacturer works at optimal efficiency generally with only one particular ballast offered by that same manufacturer, whether the ballast is magnetic or electronic. If the ballast and lamp are not compatible or matched, the operation of the lamp will not be efficient, thereby adversely affecting brightness and the life of the lamp. Additionally, in the case of magnetic ballasts, each ballast has to be specifically wired for each lamp voltage input, such as 100V, 120V and so forth. Such wiring is accomplished at the manufacturer's factory or the end user is required to wire the ballast for each lamp depending on application. Therefore, a different ballast is required for each input voltage. These manufacturers often also sell dimmers, timers and controllers as separate, auxiliary components, to be used with their particular ballast design.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 is a block diagram of an electronic ballast with multiple lamp outputs, according to an embodiment of the invention.

FIG. 2 is a circuit schematic of a power factor correction circuit used in an embodiment of the invention.

FIG. 3 shows a realization of a single turn inductor used in an embodiment of the invention.

FIG. 4 shows a single housing or electronics enclosure of a multiple output electronic ballast, according to an embodiment of the invention.

### DETAILED DESCRIPTION

An embodiment of the invention is an electronic lighting ballast that represents a one-to-many solution, that is, essentially the same ballast design can be used in a wide range of different lighting applications with relatively minor changes in configuration. In some embodiments, the ballast replaces several unique HID electronic ballasts, timers, dimmers, on/off switches, and control wires, by a single unit. One or more of such functions are integrated within a single electronic enclosure, eliminating the need to employ several external or add-on components. For example, auxiliary components such as an external timer to control the duration of operation of the ballast are not needed. In other embodiments, the ballast is a universal solution in that it can be used in different countries due to its wide input voltage capability. In addition, the ballast has multiple outputs that can drive multiple electric discharge lamps in parallel, of different wattage.

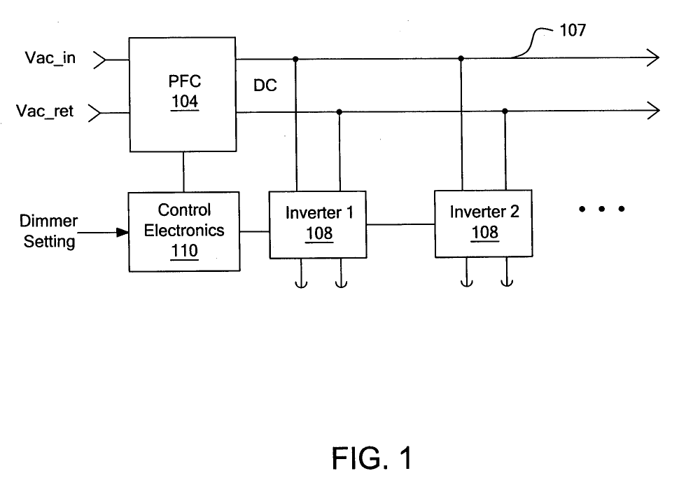

Beginning with FIG. 1, an embodiment of the electronic ballast is shown that has a power factor correction (PFC) circuit 104 having an AC mains input and a DC output. The PFC circuit 104 has a switching power supply circuit that automatically maintains a regulated DC voltage, over a relatively wide input voltage range of preferably 90 Volts AC to 500 Volts AC. For example, the PFC circuit 104 may be designed to maintain a regulated 400 DC output voltage while the AC mains input is alternatively 100-200 volts AC, and 200-300 volts AC (at either 50 Hz or 60 Hz, for example). To achieve this universal operation, part of the control electronics 110 is designed with feedback control to automatically maintain the regulated output DC voltage constant, so that there is no need to perform any rewiring or manual selection when the AC input is changed in the specified range.

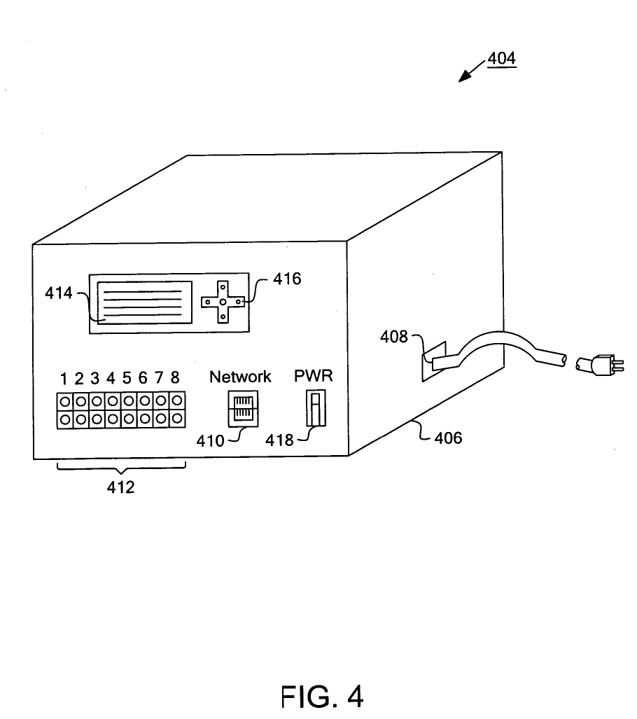

The discharge lamps can be connected to the outputs of a number of inverters 108, each being coupled to a power bus 107 in parallel as shown. The power bus 107 is coupled to the DC output of the PFC circuit 104 and may act as a power “back plane” inside the electronics enclosure of the ballast. All the elements shown in FIG. 1 may be integrated within the enclosure (see FIG. 4 and accompanying text description for an example of the enclosure).

Each inverter has a respective lamp output to drive a respective, electric discharge lamp. Each output of an inverter drives a single discharge lamp, at a time. The inverter 108 is capable of providing the needed AC waveform to ignite and then continuously operate the lamp, at the lamp's predetermined wattage rating. Each inverter regulates the electrical current used by its respective connected lamp, up to a maximum level that is a function of the total number of lamps that are being driven off the DC output of the PFC circuit 104, the maximum available power from the DC output, and the rated wattage of the lamps. Examples of discharge lamps include HID lamps identified by the gas within, namely MH, HPS, and MV.

Still referring to FIG. 1, the electronic ballast has at least two inverters 108. It preferably has three or more, that allow the ballast to alternatively drive a) three or more “low” power discharge lamps simultaneously, and b) fewer, “medium” power discharge lamps. The design is such that as another alternative, still fewer, “high” power discharge lamps can be driven simultaneously. To explain using an example, consider an embodiment where there are eight lamp outputs (corresponding to eight inverters 108). The PFC circuit 104 may be designed in that case to have sufficient output power to drive eight lamps of 175 watts each simultaneously. In addition, the inverters are designed so that those eight lamps may be replaced with only six lamps of 250 watts each (using six out of the eight inverters to drive the lamps). In still another alternative, the six lamps may be replaced with four 400 watt lamps (driven by four inverters only).

The PFC regulates tightly the DC voltage on the bus feeding the inverters at a level as needed by a particular lamp type and dimming level. The inverter circuit may provide the ignition function and a steady-state AC waveform which sets the correct rms value of the AC waveform at a lamp input, for each different lamp type and at the rated output power of each lamp. The lamps may be dimmed by lowering the DC output voltage of the PFC, which proportionally lowers the rms value of lamp input, AC waveforms, without any further action taken by the inverter. The inverter does not need settings for different lamp types and lamp manufacturers.

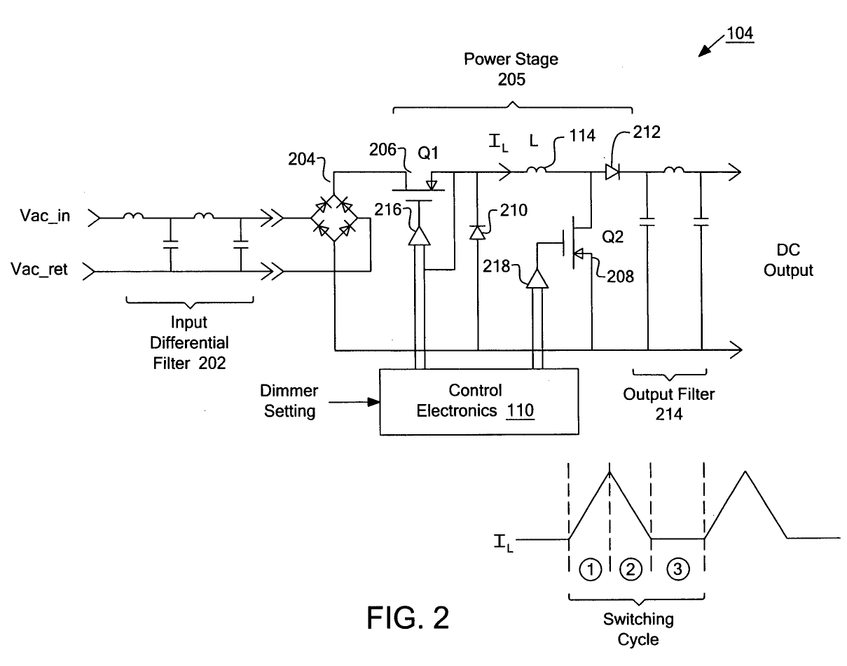

Turning now to FIG. 2, a schematic of part of the PFC circuit 104 is shown, according to an embodiment of the invention. The schematic shows a switching power supply circuit (also referred to as a power stage 205) that has a non-inverting, buck-boost converter configured to operate in discontinuous conduction mode (DCM). The power stage 205 is preferably designed to deliver to the DC output about 400 Volts at an average of 200 watts or greater. An advantage to using the non-inverting buck-boost converter topology in this voltage and power range is that it provides lower voltage stresses in comparison to, for example, a boost converter topology. Achieving lower voltage stresses allows the PFC circuit to operate at higher input and/or output voltages without having to use more expensive, higher voltage rating switching power transistors.

In addition, operation in the DCM mode has inherent power factor correction in the non-inverting buck-boost topology, as compared to a boost converter topology which needs additional controls to achieve a power factor of close to one.

Still referring to FIG. 2, the power stage 205 has a first power switching transistor 206 (Q1) that is coupled in series with an input of the power stage 205 and with an inductor 114 (L). A second power switching transistor 208 (Q2) is coupled in a shunt configuration. Current is drawn by turning on Q1 and Q2, from a rectifier 204 (in this example, a half-wave rectifier). This builds up the inductor current I_{L} during a first part of a switching cycle (see the example I_{L} waveform in FIG. 2). Next, during the second part of the switching cycle, Q1 and Q2 are turned off, so that the inductor current decays down to zero. The decay in the inductor current is though diodes 210 and 212. Next, in the third part of the cycle, the current remains essentially at zero (also referred to as a rest part of the cycle). The turning on and turning off of Q1 and Q2 is under control of the control electronics 110, via drivers 216, 218. Although in this example, Q1 and Q2 are shown as field effect transistors (FETs), other types of power switching devices may be used that can provide the needed switching speed, current carrying capability, and voltage ratings. For example, consider the case where the AC input is at 480 V (RMS), and the DC output is at 400 V. For Q1 and diode 210, the maximum voltage will be about 600 V. For Q2 and diode 212, the maximum voltage will be about 400 V.

The inductor current in the second part of the switching cycle is routed into the output filter 214 of the PFC circuit. The output filter 214 may be a low pass filter that serves to smooth out the ripples in the constant DC voltage at the DC output. Note that several feedback paths are not shown in FIG. 2, including one from the DC output back to the control electronics 110, for example, where the feedback signal helps to regulate the DC output by determining how to change the duty cycles of the relatively high frequency waveforms (high as compared to frequency at the AC input of the PFC circuit) that are driving Q1 and Q2, as a function of the DC output voltage.

In addition to the output filter 214, the PFC circuit 104 also has an input differential filter 202, which is also a low pass filter that is designed to reduce the switching noise that may be fed back into the AC mains. In addition, a common mode filter (not shown) may be added to the input of the PFC, for further reducing the common mode noise that may be generated by the PFC 104 and that may otherwise be injected into the mains.

It should be noted that the control electronics 110 may include a voltage controlled oscillator and other digital logic circuitry (not shown) that operate as a controller, to change the duty cycle and/or frequency of the waveforms driving Q1 and Q2, so as to maintain (under negative feedback control) the DC output at a predetermined constant level. In a further embodiment, this regulated DC output voltage may be changed in accordance with a dimmer setting input, received from outside of the electronic ballast. The control electronics 110 may receive a dimmer setting from outside of the ballast, and in response command a change to the regulated DC voltage provided by the PFC circuit 104, to implement the dimmer function upon a number of gas discharge lamps that are being driven simultaneously by the ballast. For a lower dimmer setting, that is, less light output, the DC output voltage would be reduced. To increase light output, in response to the dimmer setting being higher, the DC output would be increased. However, in the steady state, the DC output level would remain fixed regardless of variations in the AC input voltage to the PFC circuit or the load presented by the inverters 108.

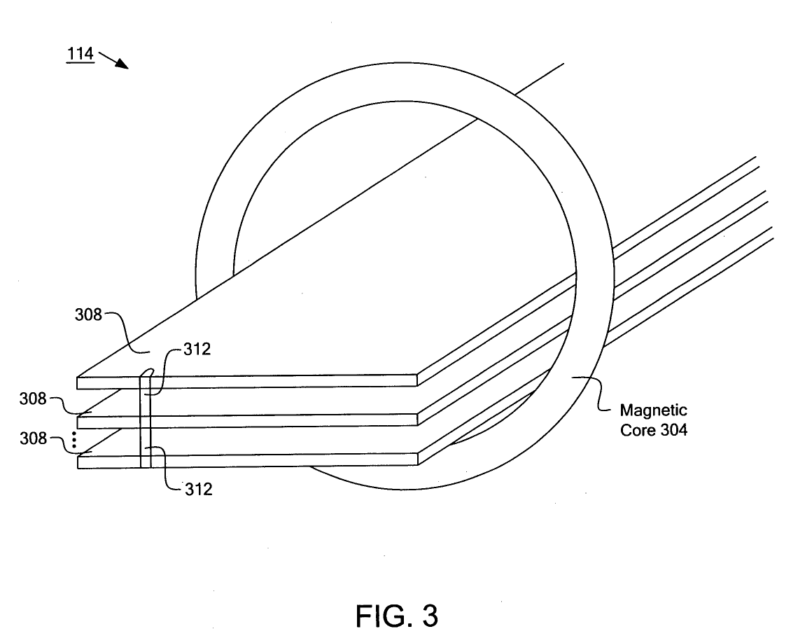

Turning now to FIG. 3, an example inductor 114 is shown that has a single turn. The single turn inductor is achieved in this case by one or more magnetic cores 304 and a multi-layer printed wiring board, where multiple conductive layers 308 of the board are shorted to each other and pass through the cores only one time. The core may be, for example, an MPP-type core typically used in switching power supply circuits. The layers 308 may be shorted to each other by vias 312. Each layer 308 may be similar to a ground or power plane that may run almost the full width of the board. Such a structure allows for efficiently handling PFC average output power levels of at least 1600 watts (e.g., at about 400 VDC) and at least 130 amp peak inductor currents. Since the inductor current is pulsating, as described above using the example of essentially a triangular waveform with rest portions, increasing the number of turns in the inductor 114 may create significant “i²r” conductive losses, as well as core losses in the form of extra heat being generated in the core. The single turn embodiment described here reduces magnetic flux density in the core and thus helps reduce such core losses.

Inverters

The inverter 108 may incorporate switching power supply circuitry that generates a relatively high frequency AC voltage/current waveform (e.g., 100 KHz) needed to efficiently ignite and then drive a discharge lamp that is connected to its output. Each inverter may be implemented using an L6598 resonant controller from STMicroelectronics, with a half-bridge power stage and an LC output network. The L6598 is the controller part of the inverter, and includes a voltage controlled oscillator, control logic, and driving logic for the half-bridge power stage. The controller allows a change to the frequency of the oscillator, by way of a F-CTRL input. The inverter output current will in turn depend on the oscillator's operating frequency, where a higher frequency may be used to obtain a lower output current. As to the power stage, a pair of pull up and pull down power field effect field transistors may be used, which are switched on and off by the controller to achieve the desired output waveform. Other types of controllers and power stages are also possible.

The control electronics 110 may also include further control circuitry in the form of, for example, a programmable microprocessor that can command a change in one or more operating parameters of each individual inverter 108. The further control circuitry provides changes to one or more operating parameters, so as to meet the electrical current, voltage, and/or power requirements of the particular lamp that is connected to the output of the converter. For example, to ignite the lamp, the inverter is commanded to generate a relatively high frequency waveform that is initially very close to the resonant frequency of a resonant tank circuit. This resonant tank circuit may be formed by the combination of the lamp and an LC network at the output of the inverter. When a lamp has not yet ignited, and is relatively cold, it presents a relatively high resistance such that the tank circuit exhibits pure or undamped resonance. The output voltage generated by the inverter is thus magnified across the lamp. This effect is also referred to as a strike.

As the lamp ignites, its resistance drops and the lamp heats up precipitously so that the resonance effect essentially disappears. At that point, the control electronics commands the inverter to sustain the rated or nominal drive current that has been specified for the particular lamp, at a much lower voltage. The controller that is part of the inverter 108 should be designed with the appropriate sensing elements that sense, for example, output current and/or voltage across the lamp, so as to maintain the correct current by changing the output voltage. This may be achieved by adjusting the operating frequency and/or duty cycle of the switch mode power supply circuitry in the inverter, as part of an automatic feedback control loop. Other switch mode power supply control methods may alternatively be used, to achieve the desired electrical waveform at the output.

Turning now to FIG. 4, a single electronics enclosure 406 is depicted for the electronic ballast, according to an embodiment of the invention. The elements described above (and below) may all be integrated within this enclosure 406. It is expected that using the power supply switching techniques described here, the electronic ballast with enclosure 406 should weigh no more than twenty pounds while providing a total average output power (to be shared among, in this example, eight lamp outputs 412) of 1600 watts. The enclosure 406 is fitted with an AC mains input 408 that can be connected by way of a power cable, for example, to a local mains or distribution outlet. As an alternative, other ways of providing AC power, in the range of 90-500 volts AC preferably, may be used.

Each output 412 is to drive a single electric discharge lamp at a time, deriving power from the mains input 408. The enclosure 406, in this example, also has a single, on/off manually actuatable switch 418 that is operatively connected to the control electronics 110, to control the switching power supply circuits within the enclosure, so as to turn on and turn off all of the lamp outputs 412.

The embodiment of the ballast 404 depicted in FIG. 4 also has a display panel 414 that is installed in this case on the front face of the enclosure, together with a keypad 416. The panel 414 may have a liquid crystal display (LCD) screen that can show multiple lines of text or alphanumeric messages, to display the current status of operation of the ballast, to control selections for configuring ballast operation, and in certain embodiments to display diagnostic information, such as that which may be collected by electronics within the ballast.

A menu hierarchy may be shown on the display panel, which can be manually navigated by a human user actuating the keypad 416. This may be done to change or verify the status of the ballast, make selections regarding mode of operation (e.g., pre-select the lamp manufacturer, lamp type, and/or lamp wattage), and navigate through diagnostic information. A four direction, joystick-type device may be used with a center select button for the keypad 416, to navigate in four different directions on the display panel and then select the desired menu item. Other alternatives for a manual user interface are possible. Note that although shown as being installed on the same face of the enclosure as the one containing the lamp output, alternative locations for the display panel and/or the keypad on other faces of the enclosure are possible.

The embodiment of the electronic ballast shown in FIG. 4 also has a cable connector 410, to make a wire line communications connection or link between the ballast 404 and a remote machine (not shown). In other embodiments, this communications link may be in accordance with a wireless networking standard. The link allows operation of the ballast to be changed and monitored remotely.

Integrated Lamp Functions

The control electronics 110 that is installed in a ballast enclosure may be based on one or more microcontrollers that are executing firmware which allows one or more of a number of lamp functions to be implemented. These functions include timer and scheduling (turn on and turn off of a particular lamp output at certain times of the day for certain durations), dimming, measurement of the temperature in the circuit boards and power stages of the ballast, lamp output current and lamp voltage measurement, lamp selection (including type, manufacture, and/or wattage), as well as detection of ignition and fault conditions.

A separate microcontroller may also be used to interact with the user either through a local interface on the enclosure, or through a remote graphical user interface. For example, a microcontroller such as the ATMEGA8-16AI integrated circuit by ATMEL may be installed in the enclosure and that is coupled to scan a keypad, manage a display panel, and exchange data relating to user selections, or to any other item to displayed, with a central processing unit (CPU). The CPU may be a separate microcontroller, such as an ATMEGA32-16AI integrated circuit by ATMEL that executes firmware to implement the lamp operation functions described above. An example implementation of these functions, that have been integrated into a single ballast enclosure, are as follows.

The control electronics 110 that is installed in the enclosure (e.g., including a microcontroller and associated attendant circuitry) may be coupled to control the inverter and to receive a selection of lamp load type, so that the same lamp output can alternatively drive a high pressure sodium lamp and a metal halide lamp, for example, without requiring a separate inverter. The microcontroller thus controls the power switching stages so that the single lamp output can drive each of the different types of lamps in an efficient manner, to not adversely affect brightness and the life of each lamp. In another embodiment, the ballast may be designed so that the different lamp types that can be driven by the same output include a high pressure sodium, a metal halide, and a mercury vapor lamp. The “mapping” between each type of lamp and the commands needed to configure the switching power stages may be described as follows. Responding to queries that appear on the digital display located on the ballast enclosure, the user selects, using the keypad buttons, between the alternatives programmed into the firmware, with a designation of lamp type, lamp wattage, and lamp manufacturer. As an alternative, the user choices of lamp type, lamp wattage, and lamp manufacturer may be indicated by setting DIP switches within the ballast enclosure.

A lamp turn on procedure may be as follows. Upon power up of the control electronics in the ballast, the type of lamp to be driven is first determined (e.g., by reading a switch setting or menu selection that has been made by the user either locally or remotely). Next, the following turn on sequence for the power switching stages is observed: first, the PFC circuit is initiated, and then the inverters. This is because the power factor correction circuit may have some difficulty starting up without a load. A fixed or electronically adjustable preload can alternatively be used to accomplish the proper startup of the PFC, but the sequencing described above provides a more efficient and cost effective method.

The initial settings may be designed to drive the particular type of lamp that has been selected, at its nominal power rating, e.g. maximum brightness. Once the lamp has warmed up and is being driven, a dimmer level is obtained by the control electronics (e.g., by reading a dimmer switch setting or menu selection). The desired dimming level is then obtained by commanding a change to or adjusting the DC output voltage of the PFC. A number of predefined, discrete dimmer levels may be mapped to their corresponding PFC output voltage and inverter operating frequency, for each type of lamp.

In addition to, or as an alternative to, the ability to select the type of lamp to be driven by a given lamp output, another embodiment of the invention has the needed control logic to control an inverter, so that various manufacturer-specific lamps of various wattages can be driven by the same lamp output. Thus, the enclosure of the single ballast may include, in addition or as an alternative to a lamp load type selector, a lighting manufacturer selector which provides a selection by the user to the programmable microprocessor control circuitry. The programmable microprocessor may then access a predefined lookup table, for example, for the particular combination of lamp load type and/or lighting manufacturer, as well as rated lamp wattage selection (received from a separate wattage selector) to determine which operating parameters of the PFC circuit and/or inverter to change so as to appropriately ignite and drive the lamp that will be connected.

There are at least two types of user interfaces that may be installed within the enclosure of the ballast and that allow a user to manually select a setting for the lamp to be driven. In the version depicted in FIG. 4, this user interface includes the display panel 414 and keypad 416. In contrast, an economy version may alternatively have, for example, a simple rotary multi-position switch installed in the enclosure, for the user to make his/her selections. As an alternative or as an addition to a rotary switch, a DIP switch may be installed in the enclosure to perform the same selection (while providing more difficult access). In the economy version, some or all of the programmable microprocessor control may not be needed due to the reduced functionality (e.g., no network communications capability), and instead suitable control logic may be provided to translate the combination of lamp selections into the needed commands for configuring operation of the PFC circuit and inverter 108. The control logic may also be designed to receive a dimmer level through a dedicated dimmer selector (not shown), and in response configure the power switching stages appropriately to achieve the desired dimming level.

It should be noted that in some embodiments, such as ballasts for driving HID lamps, the microprocessor control circuitry will start a timer (e.g., 15 minutes) after initially enabling the lamp output to drive the lamp, which disables the dimming function until a predetermined interval of time has elapsed with the lamp on. Also, many high intensity discharge lamps are not actually designed to be dimmed, and are typically only operated at their nominal rated brightness. In such cases, the dimming function provided here may reduce the luminosity by no more than fifty percent or to another pre-determined, non-zero level, in contrast to conventional incandescent dimming capabilities which can reduce luminosity continuously down to essentially zero percent.

The invention is not limited to the embodiments described above. For example, the voltage and frequency numbers used to describe operation of certain elements of the ballast may only apply to some, not all, of the different embodiments of the invention. They are sometimes used only as examples and are not intended to limit the scope of the invention (e.g., 100 KHz switching frequency). In addition, although in the circuit schematics here, only a single device may have been shown, such as a single transistor or a single diode, several of such devices may be connected in parallel to reduce current stresses. Accordingly, embodiments other than those explicitly illustrated or described above may be within the scope of the claims.

What is claimed is:

1. An electronic ballast comprising:
an electronics enclosure; and
a plurality of elements integrated within the enclosure, including
a power factor correction (PFC) circuit having an AC input and a DC output, the PFC circuit having a switching power supply circuit to automatically provide the same, regulated DC voltage based on the AC input being alternatively (a) 100-200 Volts AC and (b) 200-300 Volts AC,
a power bus coupled to the DC output,
a plurality of inverter circuits coupled to the power bus in parallel, each inverter circuit having a respective output to drive a respective, electric discharge lamp, and
control electronics coupled to the PFC circuit to command a change to the regulated DC voltage in response to a dimmer setting.

2. The electronic ballast of claim 1 wherein the plurality of inverters number at least three, and allow the ballast to alternatively drive (a) three or more low power electric discharge lamps simultaneously, (b) fewer medium power electric discharge lamps simultaneously, and (c) still fewer high power electric discharge lamps simultaneously.

3. The electronic ballast of claim 2 wherein the switching power supply circuit of the PFC circuit comprises a non-inverting buck-boost converter configured to operate in discontinuous conduction mode with the DC output at an average 200 W or greater.

4. The electronic ballast of claim 1 wherein the switching power supply circuit of the PFC circuit comprises a non-inverting buck-boost converter configured to operate in discontinuous conduction mode with the DC output at an average 200 W or greater.

5. The electronic ballast of claim 1 wherein the switching power supply circuit of the PFC circuit comprises an inductor in series with the DC output that has a single turn.

6. The electronic ballast of claim 1 wherein the switching power supply circuit of the PFC circuit comprises an inductor in series with the DC output, the inductor comprising a core and a multi-layer printed wiring board wherein multiple conductive layers of the board are shorted to each other and pass through the core.

7. An electronic ballast comprising:
an electronics enclosure; and
a plurality of elements integrated within the enclosure, including
a non-inverting, buck-boost converter configured to operate in discontinuous conduction mode designed to provide an average power of more than 200 Watts at its DC output,
a power bus coupled to the DC output, and
a plurality of inverter circuits coupled to the power bus in parallel, each inverter circuit having a respective output to drive a respective, electric discharge lamp.

8. The electronic ballast of claim 7 wherein the plurality of inverters number at least three, and allow the ballast to alternatively drive (a) three or more low power electric discharge lamps simultaneously, (b) fewer medium power electric discharge lamps simultaneously, and (c) still fewer high power electric discharge lamps simultaneously.

9. The electronic ballast of claim 8 wherein the non-inverting buck-boost converter comprises an inductor in series with the DC output that has a single turn.

10. The electronic ballast of claim 7 wherein the non-inverting buck-boost converter comprises an inductor in series with the DC output that has a single turn.

11. The electronic ballast of claim 7 wherein the non-inverting buck-boost converter comprises an inductor in series with the DC output, the inductor comprising a core and a multi-layer printed wiring board wherein multiple conductive layers of the board are shorted to each other and pass through the core.

12. The electronic ballast of claim 7 further comprising, integrated within the enclosure, a rectifier circuit having an output coupled to an input of the converter, and wherein the converter comprises first and second field effect transistors (FETs) and an inductor, the first FET being coupled in series with the input of the converter and with the inductor, the second FET being coupled in a shunt configuration.

13. A method for operating an electronic ballast, comprising:
connecting five or more first electric discharge lamps at least 100 Watts each to five or more outputs, respectively, of an electronic ballast unit that weighs less than twenty pounds and includes an integrated dimming function;
connecting an input of the electronic ballast unit to AC power;
setting a dimmer level for the electronic ballast unit;
operating the connected first electric discharge lamps at their rated wattage;
replacing the five or more first electric discharge lamps with at least three second electric discharge lamps at least 300 Watts each; and
operating the connected second electric discharge lamps at their rated wattage.

14. The method of claim 13 wherein the five or more first electric discharge lamps are replaced with three of said second electric discharge lamps.

15. The method of claim 13 when the five or more first electric discharge lamps are replaced with four of said second electric discharge lamps.
